(19) United States
(12) Patent Application Publication
(10) Pub. No.: US 2012/0215480 A1
(43) Pub. Date: Aug. 23, 2012

(54) COMPUTING DEVICE AND PROGRAMMING METHOD FOR A THREE-DIMENSIONAL MEASUREMENT MACHINE

(75) Inventors: CHIH-KUANG CHANG, Tu-Cheng (TW); XIN-YUAN WU, Shenzhen City (CN); MIN WANG, Shenzhen City (CN); TAO TANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/294,197

(22) Filed: Nov. 11, 2011

(30) Foreign Application Priority Data
Feb. 21, 2011 (CN) 201110042264.X

(51) Int. Cl. G06F 19/00

(52) U.S. Cl. 702/123

(57) ABSTRACT

In a programming method, a program template of a measurement program and a 3D measurement element document of a product is imported from a storage system. The method establishes a data format of the 3D measurement element document according to a data format of the program template, and defines a modification rule and a delete rule of the 3D measurement element document according to keywords in lines of the program template. By replacing the keywords and data of the program template with data saved from the 3D measurement element document a measurement program is obtained. The method outputs the measurement program and displays the measurement program on a display screen.

### BACKGROUND

1. Technical Field

Embodiments of the present disclosure relate to computing devices and methods for generating measurement programs, and more particularly to a computing device and a programming method for a three-dimensional measurement machine thereof.

2. Description of Related Art

Three-dimensional (3D) measurement is widely used in manufacturing by designers, for assessing newly developed molds. Different kinds of 3D measurement machines identify measurement programs written in designated languages or translators, such as Virtual DMIS and PC-DMIS. During the creation of a measurement program, errors in the program code are difficult for the designer to find. Errors in the program code may cause the touch-probe of the 3D measurement machine to collide with the object being measured. Therefore, an improved method is desirable to address the aforementioned issues.

### BRIEF DESCRIPTION OF THE DRAWINGS

FIG. 1 is a block diagram of one embodiment of a computing device including a programming unit.

FIG. 2 is a block diagram of function modules of the programming unit of FIG. 1.

FIG. 3 is a flowchart illustrating one embodiment of a programming method for a three-dimensional measurement machine.

### DETAILED DESCRIPTION

In general, the word “module,” as used hereinafter, refers to logic embodied in hardware or firmware, or to a collection of software instructions, written in a programming language, such as, for example, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

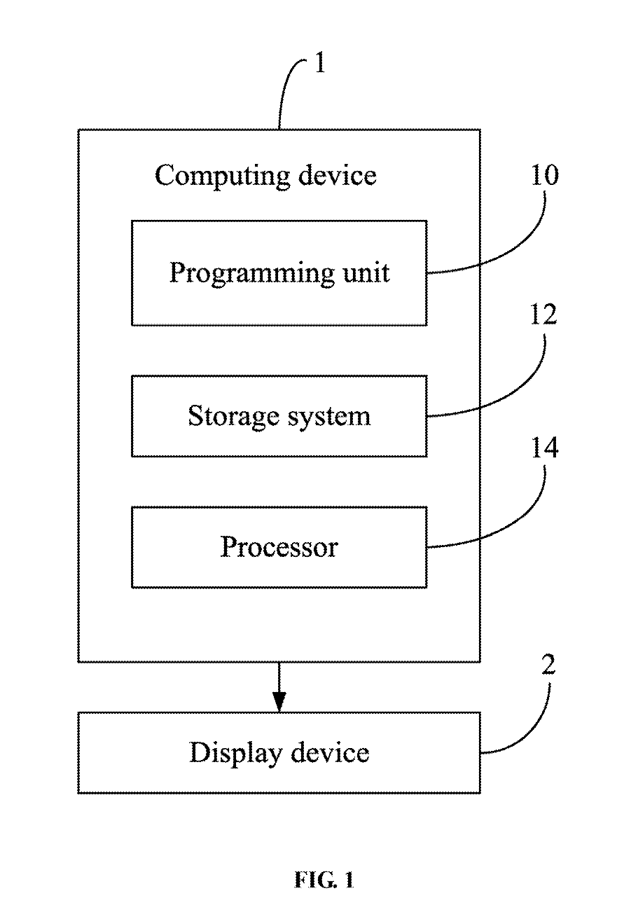

FIG. 1 is a block diagram of one embodiment of an computing device 1 including a programming unit 10. In the embodiment, the functions of the programming unit 10 are implemented by the computing device 1. The programming unit 10 enerates a measurement program based on a program template and a three-dimensional (3D) measurement element document (element document) of a product. The measurement program is executable by the computing device 1. The measurement program is a software program takes measurements of the product according to a basic command library, to measure other products of the same type.

In the embodiment, the computing device 1 may be a computer, a server, a portable electronic device, or any other electronic device that includes a storage system 12, and at least one processor 14. The computing device 1 is electronically connected to a display device 2. The display device 2 is used for displaying the measurement program.

In the embodiment, the program template is a basic sample or copy of a measurement program, and may include program codes, a data format, data types, and keywords of the program codes. The element document is used for saving measurement information of a product measured by a 3D measurement machine. The measurement information may include information related to measurement elements, such as coordinate values of the measurement elements. A measurement element may be a point, a straight line, a plane, or a circle, for example.

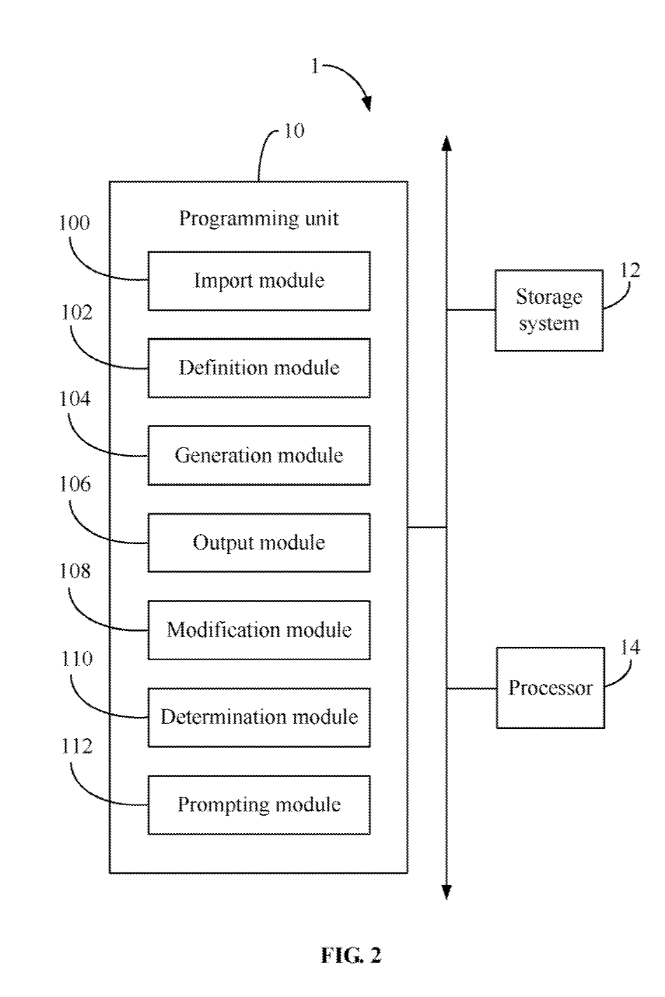

FIG. 2 is a block diagram of function modules of the programming unit 10 of FIG. 1. In one embodiment, the programming unit 10 includes an import module 100, a first definition module 102, a generation module 104, an output module 106, a modification module 108, a determination module 110, and a prompting module 112. Each of the modules 100-112 may be a software program including one or more computerized instructions that are stored in the storage system 12 and executed by the processor 14. The processor 14 may be a central processing unit or a math co-processor, for example.

In the embodiment, the import module 100 imports a program template and an element document of a product from the storage system 12.

The first definition module 102 establishes a data format of the element document according to a data format of the program template, so the data format both of the element document and the program template are the same.

For example, the data format of the program template of the embodiment may be described as follows:

[FEAT/]
line0=“$strValue =FEAT/$strElementType”;
line1=“ACTUAL/$dValue,$dValue,$dValue,$dValue,$dValue,$dValue”;
line2=“PTMEAS/CART,$dValue,$dValue,$dValue,$dValue,$dValue,
$dValue”;
line3 = “ENDMES”.

In the program template, the character string “$strElementType” represents that the measurement element is a point, a straight line, a plane, or a circle. Data in the program template is separated by a comma. Character strings and keywords of the program template are identified by the symbols “=” or “/”.

The first definition module 102 further reads keywords in the lines of the program template, and defines a modification rule and a delete rule of the 3D measurement element document according to the keywords. In the embodiment, the modification rule defines which data is available for modification, and which data is unavailable for modification. The data which is available for modification is defined according to a designer's requirement. For example, defines that keywords is unavailable for modification, and data types is available for modification. The delete rule is a rule for deleting data, for example, if a line of the element document is selected for deletion, deleting a whole program section where the line is; if a part of data having one or more symbols (such as “=”, “/” or “,”) in the line is selected for deletion, the part of data cannot be deleted; or if a plurality of data having no symbol is selected for deletion, deleting the plurality of data. In the embodiment, the program section is a sub-program of the measurement program, and each program section has a section name, such as “S1,” “S2,” and “S3.”

As shown in the example of the program template, the character strings “FEAT/$strElementType,” “ACTUAL/”, “PTMEAS/CART” and “ENDMES” are keywords. The character strings “$dValue” represent that the data types of measurement elements are a “double” type.

The generation module 104 replaces the keywords and data of the program template with data from the element document, and obtains a measurement program.

For example, if the data recorded in the element document is four points on a circle, the generation module 104 replaces the keywords and data of the program template with data from the element document, and obtains a measurement program. A part of the measurement program is named as a program section and may be described as follows:

S1 =FEAT/CIRCLE;
ACTUAL/2.-424,3.123,1.000,0.000,-0.000,1.000,0.696;
PTMEAS/CART,2.193,3.101,1.000,0.0000,0.0000,1.0000;
PTMEAS/CART,2.020,0.937,1.000,0.0000,0.0000,1.0000;
PTMEAS/CART,3.716,1.155,1.000,0.0000,0.0000,1.0000;
PTMEAS/CART,4.554,3.157,1.000,0.0000,0.0000,1.0000;
ENDMES.

In the above program section, “S1” is a section name. The keyword “FEAT/$strElementType” in the program template is replaced with “FEAT/CIRCLE.” The character strings “$dValue” in the program template are replaced with the coordinates of the four points. For example, the coordinates of one point of the circle is (x, y, z, i, j, k)=(2.193,3.101,1.000,0.0000,0.0000,1.0000). In the embodiment, the data in each line of the measurement program has the same data format, the same data type, and the same number of measurement elements as the program template.

The output module 106 outputs the measurement program and displays the measurement program on the display device 2.

In other embodiments, any errors in the measurement program generated by the generation module 104 can be corrected. The modification module 110 receives any designer modifications of the measurement program. The modifications also comply with the modification rule and the delete rule.

As shown in the following paragraph, the headwords in the program section “S1” are the modified data:

S1 =FEAT/CIRCLE;

ACTUAL/2.424,3.123,1.000,0.000,-0.000,1.000,0.696;
PTMEAS/CART,2.693,3.601,1.000,0.0000,0.0000,1.0000;
PTMEAS/CART,2.820,2.937,1.060,0.0000,0.0070,1.0000;
PTMEAS/CART,2.716,1.355,1.000,0.0080,0.0000,1.0000;
PTMEAS/CART,4.554,3.157,1.000,0.0000,0.0000,1.0090;
ENDMES.

In the embodiment, the designer also can select the data of the measuring program to be deleted. For example, if the measuring program has three program sections: a first program section named “S1,” a second program section named “S2,” and a third program section named “S3”:

```
S1 =FEAT/POINT;
    ACTUAL/2.321,3.715,1.000,0.000,1.000;
    PTMEAS/CART,2.321,3.715,1.000,0.000,0.000,1.000;
    ENDMES.
S2 =FEAT/LINE;
    ACTUAL/3.321,4.715,1.000,0.70710,1.000,0.920;
    PTMEAS/CART,3.351,4.215,1.000,0.000,0.000,1.000;
    PTMEAS/CART,3.611,3.370,1.000,0.000,0.000,1.000;
    ENDMES.
S3 =CONST/POINT,MID,S1,S2;
    ACTUAL/2.971,3.714,1.000,0.70710,1.000,1.000.
```

If the line “PTMEAS/CART,2.321,3.715, 1.000,0.000,0.000,1.000” in the first program section is selected, the whole program section is deleted, the measuring program after the deletion is described as follow:

```
S2 =FEAT/LINE;
    ACTUAL/3.321,4.715,1.000,0.70710,1.000,0.920;
    PTMEAS/CART,3.351,4.215,1.000,0.000,0. 0,1.000;
    PTMEAS/CART,3.611,3.370,1.000,0.000,0.000,1.000;
    ENDMES.
S3 =CONST/POINT,MID,S1,S2;
    ACTUAL/2.971,3.714,1.000,0.70710,1.000,1.000.
```

If the data containing “4.215” in the second program section contains a comma (,) is selected for deletion, the data cannot be deleted. If the selected data does not include a symbol, the data can be deleted, for example, if “00” in the data “0.000” is selected, then “00” can be deleted.

During correction of the measuring program, the modification module 110 collects information to identify the location (position identification) of all the modified data, namely a position identification of each modified data. In one embodiment, the position identification may include the program section containing the modified data and a line of the modified data in the program section.

The determination module 110 searches the program template for data corresponding to the modified data, and determines whether the data type of the modified data is the same as the data type in the program template. For example, if the data type of the modified data is a string type, and the data type in the program template is a double type, the determination module 110 determines that the data type of the modified data is different from the data type in the program template. The prompting module 112 outputs an error message and marks the modified data with color(s) or highlight(s), in bold type, in italic type or other distinctive formatting. For example, the prompting module 112 marks the modified data in italic type.

For example, if the data type of the modified data is different from the data type of the program template, the prompting module 112 outputs an error message and marks the modified data in the first program section in italic type. The first program section before any modification is described below:

S1 =FEAT/CIRCLE;

ACTUAL/2.-424,3.123,1.000,0.000,-0.000,1.000,0.696;
PTMEAS/CART,2.193,3.101,1.000,0.0000,0.0000,1.0000;
PTMEAS/CART,2.020,0.937,1.000,0.0000,0.0000,1.0000;
PTMEAS/CART,3.716,1.155,1.000,0.0000,0.0000,1.0000;
PTMEAS/CART,4.554,3.167,1.000,0.0000,0.0000,1.0000;
ENDMES.

The first program section after the modification is marked below:

```
S1 =FEAT/CIRCLE;
  ACTUAL/2.-424,3.123,1.000,0.000,-0.000,1.000,0.696;
  PTMEAS/CART, [symbol]   1.000, [symbol]   0.0000, [symbol]
  PTMEAS/CART, [symbol]   0.937,1.000,0.0000,0.0000, [symbol]
  PTMEAS/CART, [symbol]   0.0000,0.0000,1.0000;
  PTMEAS/CART,4.5549,3.1657,1.000, [symbol]   0.0000,1.0000;
  ENDMES.
```

In the embodiment, the data marked by the prompting module 112 needs to be further modified. The first program section after the further modification is described below:

S1 =FEAT/CIRCLE;

ACTUAL/2.-424,3.123,1.000,0.000,-0.000,1.000,0.696;
PTMEAS/CART,2.993,3.601,1.000,0.0000,0.0000,1.0000;
PTMEAS/CART,2.620,4.937,1.000,0.0000,0.0000,1.0000;
PTMEAS/CART,3.216,2.755,1.000,0.0000,0.0000,1.0000;
PTMEAS/CART,4.154,3.157,1.000,0.0000,0.0000,1.0000;
ENDMES.

It should be noted that the data in the “ACTUAL” line cannot be modified.

In the embodiment, the determination module 110 further determines whether the modified data is a section name, and, if it is, determines whether the section name has appeared in the measurement program. If the section name has not appeared in the measurement program, the prompting module 112 further outputs an error message and marks the modified data. For example, the measuring program includes three program sections, named “S1,” “S2,” and “S3.” Details of the three program sections are described as follow:

```
S1 =FEAT/POINT;
    ACTUAL/2.321,3.715,1.000,0.000,1.000;
    PTMEAS/CART,2.321,3.715,1.000,0.000,0.000,1.000;
    ENDMES.
S2 =FEAT/LINE;
    ACTUAL/3.321,4.715,1.000,0.70710,1.000,0.920;
    PTMEAS/CART,3.351,4.215,1.000,0.000,0.000,1.000;
    PTMEAS/CART,3.611,3.370,1.000,0.000,0.000,1.000;
    ENDMES.
S3 =CONST/POINT,MID,S1,S2;
    ACTUAL/2.971,3.714,1.000,0.70710,1.000,1.000.
```

If the designer modifies the program section named “S3,” and changes the section name from “S2” to “S4.” If the section name “S4” does not appear in the measurement program, the prompting module 112 marks the section name “S4” in italic type:

S3 =CONST/POINT,MID,S1, [symbol]
ACTUAL/2.971,3.714,1.000,0.70710,1.000,1.000.

The output module 106 outputs the modified measurement program and displays the modified measurement program on the display device 2.

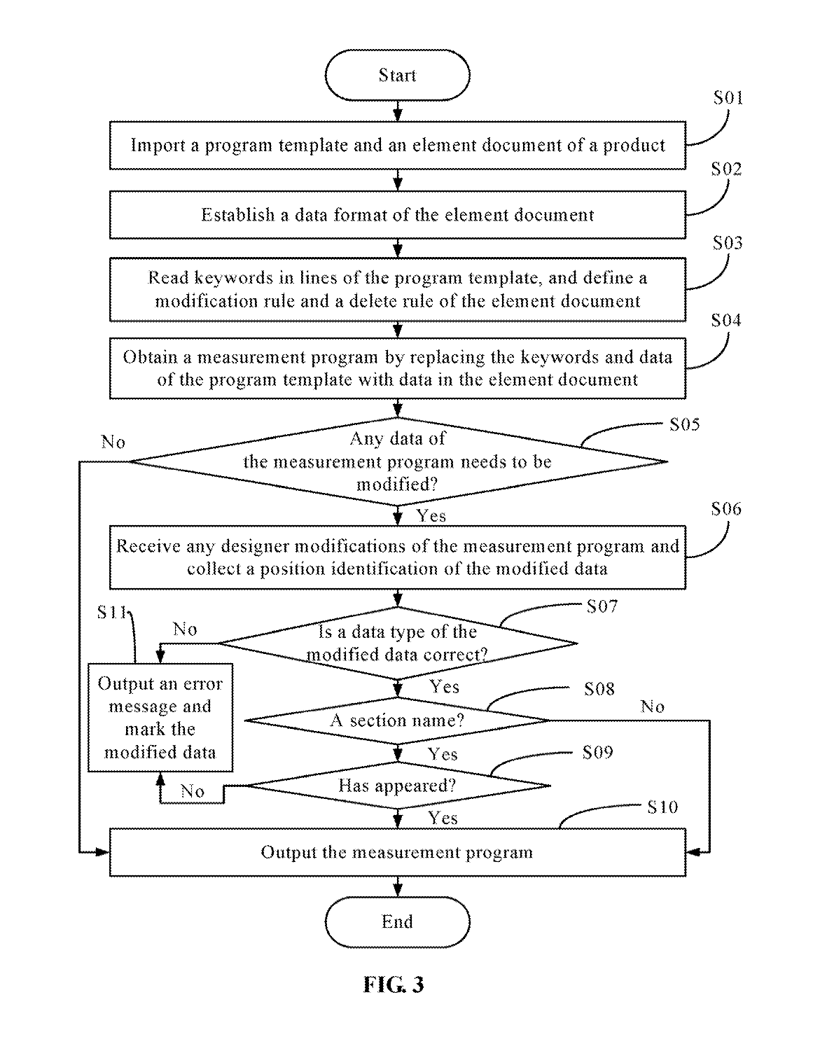

FIG. 3 is a flowchart illustrating one embodiment of a programming method for a 3D measurement machine. The method can be performed by the execution of a computer-readable program by at least one processor 14 of the computing device 1. Depending on the embodiment, in FIG. 3, additional blocks may be added, others removed, and the ordering of the blocks may be modified.

In block S01, the import module 100 imports a program template and an element document of a product from the storage system 12.

In block S02, the first definition module 102 establishes a data format of the element document according to a data format of the program template, so the data formats of both of the element document and the program template are the same.

In block S03, the first definition module 102 reads keywords in the lines of the program template, and defines a modification rule and a delete rule of the 3D measurement element document according to the keywords. As mentioned above, the modification rule is used for defining which data is available for modification and which data is unavailable for modification. For example, the first definition module 102 defines that keywords are unavailable for modification, and that data type is available for modification. The delete rule is a rule for deleting data, for example, if a line of the 3D measurement element document is selected for deletion, deleting a whole program section where the line is, if a part of data in the line having one or more symbols is selected to be deleted, the deletion will not be applied, and if the part of data in the line without a symbol, deleting the plurality of data from the 3D measurement element document.

In block S04, the generation module 104 replaces the keywords and data of the program template with data from the element document, and obtains a measurement program. The measurement program can be displayed on the display device 2.

In block S05, the modification module 110 determines whether any data of the measurement program needs to be modified. If any data needs to be modified, the flow goes to block S06. If no data in the measurement program needs to be modified, the flow proceeds to block S10.

In block S06, the modification module 110 receives any designer-modifications of the measurement program, collects information as to the location(s) and position(s) (namely the position identification) of any modified data, and searches the program template for data corresponding to the modified data. In one embodiment, the position identification may include the program section containing the modified data and a line of the modified data in the program section.

In block S07, the determination module 110 determines whether the data type of the modified data is correct. In detail, if the data type of the modified data is identical to the data type in the program template, the determination module 110 determines that the data type of the modified data is correct, and the flow goes to block S08. If the data type of the modified data is different from the data type of the program template, the determination module 110 determines that the data type of the modified data is incorrect, and the flow goes to block S11.

In block S08, the determination module 110 determines whether the modified data is a section name. If the modified data is a section name, the flow goes to S09. If the modified data is not a section name, the flow goes to S10.

In block S09, the determination module 110 determines whether the section name has appeared in the measurement program. If the section name has appeared, the flow goes to block S10. If the section name has not appeared in the measurement program, the flow goes to block S11.

In block S10, the output module 106 outputs the measurement program and displays the measurement program on the display device 2.

In block S11, the prompting module 112 outputs an error message and marks the modified data in the first program section with color(s) or highlight(s), in bold type, in italic type or another type of distinctive text formatting. For example, the prompting module 112 marks the modified data in italic type.

Although certain inventive embodiments of the present disclosure have been specifically described, the present disclosure is not to be construed as being limited thereto. Various modifies or modifications may be made to the present disclosure without departing from the scope and spirit of the present disclosure.

What is claimed is:

1. A programming method for a three-dimensional (3D) measurement machine using a computing device, the method comprising:
importing a program template and a 3D measurement element document of a product from a storage system of the computing device;
establishing a data format of the 3D measurement element document according to a data format of the program template;
reading keywords in lines of the program template, and defining a modification rule and a delete rule of the 3D measurement element document according to the keywords;
obtaining a measurement program of the 3D measurement machine by replacing keywords and data of the program template with data from the 3D measurement element document; and
outputting the measurement program and displaying the measurement program on a display device that is electronically connected to the computing device.

2. The method as described in claim 1, wherein the modification rule defines which keywords in the measurement program are available for modification, and data types of measurement elements in the measurement program are unavailable for modification.

3. The method as described in claim 1, wherein the delete rule comprises:
if a line of the element document is selected for deletion, deleting a whole program section where the line is;
if a part of data having one or more symbols in the line is selected for deletion, the part of data cannot be deleted; and
if a plurality of data having no symbol is selected for deletion, deleting the plurality of data.

4. The method as described in claim 1, further comprising:
receiving designer modifications of the measurement program according to the modification rule and the delete rule;
collecting a position identification of the modified data, wherein the position identification includes a program section containing the modified data and a line of the modified data in the program section;
searching the program template for data corresponding to the modified data;
determining whether the data type of the modified data complies with the data type of in the program template;
outputting an error message and marking the modified data upon the condition that the data type of the modified data is different from the data type of the program template.

5. The method as described in claim 4, wherein the position identification comprises a program section of the modified data and a line of the modified data in the program section.

6. The method as described in claim 4, further comprising:
outputting the error message and marking the modified data upon the condition that the modified data is a section name and the section name has not appeared in the measurement program.

7. A computing device, the computing device comprising:
at least one processor;
a storage system; and
one or more modules that are stored in the storage system and executed by the at least one processor, the one or more modules comprising:
an import module operable to import a program template and a 3D measurement element document of a product from the storage system;
a first definition module operable to establish a data format of the 3D measurement element document according to a data format of the program template;
a first definition module operable to read keywords in lines of the program template, and define a modification rule and a delete rule of the 3D measurement element document according to the keywords;
a generation module operable to obtain a measurement program of the 3D measurement machine by replacing keywords and data of the program template with data from the 3D measurement element document; and
an output module operable to output the measurement program and display the measurement program on a display device that is electronically connected to the computing device.

8. The computing device as described in claim 7, wherein the modification rule defines which keywords in the measurement program are available for modification, and data types of measurement elements in the measurement program are unavailable for modification.

9. The computing device as described in claim 7, wherein the delete rule comprises:
if a line of the element document is selected for deletion, deleting a whole program section where the line is;
if a part of data having one or more symbols in the line is selected for deletion, the part of data cannot be deleted; and
if a plurality of data having no symbol is selected for deletion, deleting the plurality of data.

10. The computing device as described in claim 7, further comprising a modification module operable to receive designer modifications of the measurement program according to the modification rule and the delete rule, and collect a position identification of the modified data, wherein the position identification includes a program section containing the modified data and a line of the modified data in the program section.

11. The computing device as described in claim 10, further comprising:
a determination module operable to search the program template for data corresponding to the modified data, and determine whether the data type of the modified data complies with the data type of the program template; and
a prompting module operable to output an error message and mark the modified data upon the condition that the data type of the modified data is different from the data type of the program template.

12. The computing device as described in claim 11, wherein the position identification comprises a program section of the modified data and a line of the modified data in the program section.

13. The computing device as described in claim 11, wherein the prompting module is further operable to output the error message and mark the modified data upon the condition that the modified data is a section name and the section name has not appeared in the measurement program.

14. A non-transitory storage medium having stored thereon instructions that, when executed by at least one processor of a computing device, causes the computing device to perform a programming method for a three-dimensional (3D) measurement machine, the method comprising:
importing a program template and a 3D measurement element document of a product from a storage system of the computing device;
establishing a data format of the 3D measurement element document according to a data format of the program template;
reading keywords in lines of the program template, and defining a modification rule and a delete rule of the 3D measurement element document according to the keywords;
obtaining a measurement program of the 3D measurement machine by replacing keywords and data of the program template with data from the 3D measurement element document; and
outputting the measurement program and displaying the measurement program on a display device that is electronically connected to the computing device.

15. The non-transitory storage medium as described in claim 14, wherein the modification rule defines which keywords in the measurement program are available for modification, and data types of measurement elements in the measurement program are unavailable for modification.

16. The non-transitory storage medium as described in claim 14, wherein the delete rule comprises:
if a line of the element document is selected for deletion, deleting a whole program section where the line is;
if a part of data having one or more symbols in the line is selected for deletion, the part of data cannot be deleted; and
if a plurality of data having no symbol is selected for deletion, deleting the plurality of data.

17. The non-transitory storage medium as described in claim 14, wherein the method further comprises:
upon a condition that a modification is required to perform on the measurement program, receiving designer modifications of the measurement program according to the modification rule and the delete rule;
collecting a position identification of the modified data, wherein the position identification includes a program section containing the modified data and a line of the modified data in the program section;
searching the program template for data corresponding to the modified data;
determining whether the data type of the modified data complies with the data type of the program template;
outputting an error message and marking the modified data upon the condition that the data type of the modified data is different from the data type of the program template.

18. The non-transitory storage medium as described in claim 17, wherein the position identification comprises a program section of the modified data and a line of the modified data in the program section.

19. The non-transitory storage medium as described in claim 17, wherein the method further comprises:
outputting the error message and marking the modified data upon the condition that the modified data is a section name and the section name has not appeared in the measurement program.
